(19) United States
(12) Patent Application Publication
(10) Pub. No.: US 2025/0073672 A1
(43) Pub. Date: Mar. 6, 2025

(54) POLYETHYLENEIMINE MODIFIED GRAPHENE OXIDES AND METHODS FOR MAKING AND USING SAME

(71) Applicant: UNIVERSITY OF LOUISIANA AT LAFAYETTE, Lafayette, LA (US)

(72) Inventors: Daniel Gang, Lafayette, LA (US); Xialbo Lei, Lafayette, LA (US); Mark E. Zappi, Lafayette, LA (US); William E. Holmes, Lafayette, LA (US)

(73) Assignee: UNIVERSITY OF LOUISIANA AT LAFAYETTE, Lafayette, LA (US)

(21) Appl. No.: 18/826,007

(22) Filed: Sep. 5, 2024

Related U.S. Application Data
(60) Provisional application No. 63/536,781, filed on Sep. 6, 2023.

(51) Int. Cl. B01J 20/26; B01J 20/32; C02F 1/28; C02F 1/72; C02F 1/78; C02F 3/10; C02F 101/34; C02F 101/36

(52) U.S. Cl. CPC B01J 20/262; B01J 20/3204; B01J 20/3272; B01J 20/3293; C02F 1/288; C02F 1/722; C02F 1/78; C02F 3/107; C02F 3/108; C02F 1/281; C02F 1/285; C02F 2101/34; C02F 2101/36

(57) ABSTRACT

Disclosed herein are polyethyleneimine modified graphene oxides and methods for using them to reduce the concentration of the contaminants in aqueous mixtures. In one specific embodiment, a polyethyleneimine modified graphene oxide includes: graphene oxide and polyethylene, where the polyethyleneimine modified graphene oxide has a weight percent of graphene oxide from about 1 wt % to about 99 wt %, and where the polyethyleneimine modified graphene oxide has a weight percent of polyethyleneimine from about 99 wt % to about 1 wt %.

### CROSS-REFERENCE TO RELATED APPLICATIONS

This application is claims benefit to provisional application titled U.S. Patent Application No. 63/536,781 filed on Sep. 6, 2023. The disclosures of that application are incorporated in full by references as if copied herein.

### BACKGROUND

### Technical Field

Polyethyleneimine modified graphene oxides, which can be used to reduce the concentration of per- and polyfluoroalkyl substances (PFAS) in aqueous mixtures, are described.

### Description of the Related Art

With the development of science and industrial technology, new “forever chemicals” falling under the per- and polyfluoroalkyl substances (PFAS) category of pollutants have globally emerged as a significant water pollution threat. Two of the most prevalent PFAS are perfluorooctanoic acid (PFOA) and perfluorooctanesulfonic acid (PFOS). PFAS have been extensively used over the last century because of its distinct capability to resist oil and grease. PFAS chemicals are thermally stable and difficult to degrade ecologically due to their high chemical bonding energy of about 110 kcal/mol of C-F in fluorocarbon. It has been detected ubiquitously in various aquatic environments such as wastewaters, where the highest PFOA (the most predominant PFAS species) concentration found was 120 mg/L at pH 4.0. Moreover, the amount of PFOA in the drinking water of nearly 6 million U.S. population exceeds the Environmental Protection Agency's (EPA) health advisory limit of 70 ppt (ng/L). Exposure to PFOA-contaminated water is significantly related to human cancers. Therefore, the extreme environmental persistence and potential human health risk of PFAS in water systems have greatly attracted the publics' attention in removing these pollutants from valuable water bodies, such as surface waters, groundwaters, and wastewater influents/effluents.

Various treatment technologies have been used in water pollution control including membrane filtration, sonochemical destruction, photo/electrocatalysis degradation, and bioremediation. Compared with these treatment methods, adsorption has exhibited several unique advantages in pollutants removal such as high stability, low energy consumption, and easy operation. Thus, adsorption is considered as a potential technique for PFAS removal in water. To date, various adsorbents have been developed and applied in PFAS removal such as resins, activated carbons (ACs), minerals, and ordered mesoporous carbons (OMCs). However, the adsorbents' low adsorption capacity and poor regeneration ability can impede their large-scale applications in engineering.

Consequently, there is a need for new adsorbent compositions and methods that can provide high PFAS uptake, fast adsorption rate, and good reusability.

### SUMMARY

Provided herein are polyethyleneimine modified graphene oxides and methods for using them to reduce the concentration of the contaminants in aqueous mixtures. In one specific embodiment, a polyethyleneimine modified graphene oxide includes: graphene oxide and polyethylene, where the polyethyleneimine modified graphene oxide has a weight percent of graphene oxide from about 1 wt % to about 99 wt %, and where the polyethyleneimine modified graphene oxide has a weight percent of polyethyleneimine from about 99 wt % to about 1 wt %.

In another specific embodiment, a method of making a polyethyleneimine modified graphene oxide includes: contacting graphene oxide with polyethyleneimine to make a polyethyleneimine modified graphene oxide, where the polyethyleneimine modified graphene oxide has a weight percent of graphene oxide from about 1 wt % to about 99 wt %, and where the polyethyleneimine modified graphene oxide has a weight percent of polyethyleneimine from about 99 wt % to about 1 wt %.

In yet another specific embodiment, a method of using a polyethyleneimine modified graphene oxide to remove a contaminant from an aqueous mixture includes: contacting a polyethyleneimine modified graphene oxide composition with an aqueous mixture containing a contaminant to at least partially reduce the concentration of the contaminant, where the contaminant comprises perfluorooctanoic acid.

### BRIEF DESCRIPTION OF THE DRAWINGS

For the purposes of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art can utilize their teachings. Therefore, no limitation of the scope of the present disclosure is thereby intended.

FIG. 1 is a graph of perfluorooctanoic acid uptake for polyethyleneimine modified graphene oxide compositions with increasing polyethyleneimine loading ratio.

FIG. 2A is a graph showing XRD patterns of graphene oxide and GO-PEIx; FIG. 2B is a graph showing the BET analysis of graphene oxide; FIG. 2C is a graph showing the BET analysis of GO-PEI3; FIG. 2D is a SEM image of graphene oxide; FIG. 2E is a SEM image of GO-PEI3; FIG. 2F is an EDS spectrum of graphene oxide; and FIG. 2G is an EDS spectrum of GO-PEI3.

FIG. 3A are FT-IR spectra of graphene oxide and GO-PEI3; FIG. 3B shows an XPS survey of graphene oxide, GO-PEI3 and GO-PEI3 after PFOA adsorption; FIG. 3C shows an XPS spectrum of C₁ₛ for GO; FIG. 3D shows an XPS spectrum of C₁ₛ for GO-PEI3; FIG. 3E shows a chemical structure for a polyethyleneimine modified graphene oxide nanocomposite.

FIG. 4A shows the initial pH effect on PFOA adsorption onto GO-PEI3; FIG. 4B shows the charge potential for graphene oxide and GO-PEI3; FIG. 4C shows a kinetic study of PFOA adsorption onto GO-PEI3 and model fitting results; FIG. 4D shows an intra-particle diffusion kinetic model fitting; FIG. 4E shows an isotherm study of PFOA adsorption onto GO-PEI3 and model fitting results; FIG. 4F shows an HA effect on PFOA adsorption onto GO-PEI3 and HA (20 mg/L) adsorption kinetics. (C₀ of PFOA: 50 mg/L, unless specified; (T: 25° C.; adsorbent dosage: 0.1 g/L; contact time: 15 h; initial solution pH: 4.0, unless specified).

FIG. 5A shows the ionic strength of PFOA adsorption onto GO-PEI3; FIG. 5B shows ions effect on PFOA adsorption onto GO-PEI3; FIG. 5C shows the isopropyl alcohol content effect on regeneration; FIG. 5D shows a regeneration study using 30% of isopropyl alcohol (C₀ of PFOA: 50 mg/L; T: 25° C.; adsorbent dosage: 0.1 g/L; contact time: 15 h; initial pH: 4.0).

FIG. 6A shows a BET model fitting of isotherm data; FIG. 6B shows FT-IR spectra of GO, GO-PEI3 and spent monolayer adsorption GO-PEI3; FIG. 6C N₁ₛ of GO-PEI3 before and after adsorption; FIG. 6D shows adsorption mechanisms.

### DETAILED DESCRIPTION

In one or more embodiments, the polyethyleneimine modified graphene oxide can include, but is not limited to: one or more polyethyleneimines and one or more graphene oxides. For example, the polyethyleneimine modified graphene oxide can include, but is not limited to: a composite of polyethyleneimine and graphene oxide, a microcomposite of polyethyleneimine and graphene oxide, a nanocomposite of polyethyleneimine and graphene oxide, mixtures thereof.

The one or more polyethyleneimine modified graphene oxides can have a molecular weight that varies widely. For example, the polyethyleneimine modified graphene oxide can have a molecular weight from a low of about 300 g/mol, about 3,000 g/mol, or about 10,000 g/mol, to a high of about 80,000 g/mol, about 100,000 g/mol, or about 200,000 g/mol. In another example, polyethyleneimine modified graphene oxides can have a molecular weight that is less than 5,000 g/mol, less than 1,000 g/mol, or less than 500 g/mol. In another example, the polyethyleneimine modified graphene oxides can have a molecular weight from about 300 g/mol to about 200,000 g/mol, about 300 g/mol to about 1,200 g/mol, about 1,000 g/mol to about 10,000 g/mol, about 2,000 g/mol to about 50,000 g/mol, about 100,000 g/mol to about 200,000 g/mol.

The polyethyleneimine modified graphene oxide can have a content of the one or more graphene oxides that can vary widely. For example, the polyethyleneimine modified graphene oxide can have a graphene oxide content from a low of about 0.1 wt %, about 5 wt %, or about 30 wt %, to a high of about 70 wt %, about 80 wt %, or about 99.9 wt %. In another example, the polyethyleneimine modified graphene oxide can have a graphene oxide content of at least 75 wt %, at least 50 wt %, or at least 25 wt %. In another example, the polyethyleneimine modified graphene oxide can have a graphene oxide content from about 0.1 wt % to about 99.9 wt %, about 5 wt % to about 95 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the graphene oxide in the polyethyleneimine modified graphene oxide can be based on the total weight of the polyethyleneimine modified graphene oxide; or based on the total weight of the one or more polyethyleneimines and the one or more graphene oxides.

The one or more graphene oxides of the polyethyleneimine modified graphene oxide can have a molecular weight that varies widely. For example, the graphene oxide can have a molecular weight from a low of about 300 g/mol, about 3,000 g/mol, or about 10,000 g/mol, to a high of about 80,000 g/mol, about 100,000 g/mol, or about 200,000 g/mol. In another example, graphene oxide can have a molecular weight that is less than 5,000 g/mol, less than 1,000 g/mol, or less than 500 g/mol. In another example, the graphene oxide can have a molecular weight from about 300 g/mol to about 200,000 g/mol, about 300 g/mol to about 1,200 g/mol, about 1,000 g/mol to about 10,000 g/mol, about 2,000 g/mol to about 50,000 g/mol, about 100,000 g/mol to about 200,000 g/mol.

The polyethyleneimine modified graphene oxide can have a content of the one or more polyethyleneimines that can vary widely. For example, the polyethyleneimine modified graphene oxide can have a polyethyleneimine content from a low of about 0.1 wt %, about 5 wt %, or about 30 wt %, to a high of about 70 wt %, about 80 wt %, or about 99.9 wt %. In another example, the polyethyleneimine modified graphene oxide can have a polyethyleneimine content of at least 25 wt %, at least 15 wt %, or at least 10 wt %. In another example, the polyethyleneimine modified graphene oxide can have a polyethyleneimine content from about 0.1 wt % to about 99.9 wt %, about 15 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the polyethyleneimines in the polyethyleneimine modified graphene oxide can be based on the total weight of the polyethyleneimine modified graphene oxide; or based on the total weight of the one or more polyethyleneimines and the one or more graphene oxides.

The one or more polyethyleneimines of the polyethyleneimine modified graphene oxide can have a molecular weight that varies widely. For example, the polyethyleneimine can have a molecular weight from a low of about 100 g/mol, about 300 g/mol, or about 500 g/mol, to a high of about 1,000 g/mol, about 2,000 g/mol, or about 5,000 g/mol. In another example, polyethyleneimine can have a molecular weight that is less than 1,000 g/mol, less than 800 g/mol, or less than 500 g/mol. In another example, the polyethyleneimine can have a molecular weight from about 300 g/mol to about 200,000 g/mol, about 300 g/mol to about 1,200 g/mol, about 1,000 g/mol to about 10,000 g/mol, about 2,000 g/mol to about 50,000 g/mol, about 100,000 g/mol to about 200,000 g/mol.

The one or more polyethyleneimine modified graphene oxides can include, but are not limited to: nano-sized particles, micro-sized particles, and mixtures thereof. For example, the polyethyleneimine modified graphene oxides can have a diameter that varies widely. In another example, the polyethyleneimine modified graphene oxides particles can have a diameter from a low about 50 nm, about 60 nm, or about 80 nm, to a high of about 140 μm, about 150 μm, or about 200 μm. In another example, the polyethyleneimine modified graphene oxides can have a diameter from about 60 nm to about 60 microns, 50 nm to about 200 μm, about 50 nm to about 100 nm, about 60 nm to about 500 nm, about 60 nm to about 10 μm, about 65 nm to about 20 μm, about 70 nm to about 110 nm, about 75 nm to about 120 nm, about 80 nm to about 150 nm, about 80 nm to about 150 μm, about 80 nm to about 200 μm, or about 100 nm to about 180 μm.

In one or more embodiments, the method for making a polyethyleneimine modified graphene oxide can include, but is not limited to: contacting one or more graphene oxides with one or more polyethyleneimines to make a polyethyleneimine modified graphene oxide. In another embodiment, the method for making a polyethyleneimine modified graphene oxide can include, but is not limited to: contacting one or more graphene oxides, one or more polyethyleneimines, one or more solvents or carrier fluids, one or more acids, one or more bases, one or more salts, and one or more additives, and to make a polyethyleneimine modified graphene oxide. The method for making a polyethyleneimine modified graphene oxide can include one or more reaction mixtures. For example, the method for making a polyethyleneimine modified graphene oxide can include a first reaction mixture, second reaction mixture, third reaction mixture, or more reaction mixtures.

The one or more polyethyleneimines can be contacted with the one or more graphene oxides in a mass ratio that can vary widely. For example, the mass ratio of the one or more polyethyleneimines to the one or more graphene oxides (wPEI/wGO) can be from about 0.2, about 0.5, about 0.7, about 1, about 2, about 3, about 4, about 5, about 6, about 7, about 8, about 9, about 10, about 11, about 12, about 13, about 14, or about 15. In another example, the mass ratio of the one or more graphene oxides to the one or more polyethyleneimines (wGO/wPEI) can be from about 0.2, about 0.5, about 0.7, about 1, about 2, about 3, about 4, about 5, about 6, about 7, about 8, about 9, about 10, about 11, about 12, about 13, about 14, or about 15.

The one or more solvents for the first reaction mixture, second reaction mixture, and catalyst mixture can include, but are not limited to: aliphatic hydrocarbons, such as hexanes; aromatic hydrocarbons, such as toluene and benzene; water; deionized water; methanol; ethanol; propanol; isopropanol; acetone; acetonitrile; chloroform; diethyl ether; methylene chloride; dimethyl formamide; ethylene glycol; propylene glycol; triethylamine; tetrahydrofuran; and mixtures thereof.

The one or more acids can include, but are not limited to, sulfuric acid, phosphoric acid, citric acid, nitric acid, hydrochloric acid, humic acid, acetic acid, carbonic acid, formic acid, and combinations thereof.

The one or more reaction mixtures can have a content of the one or more acids that can vary widely. For example, the reaction mixtures can have a content of the one or more acids from a low of about 0.1 wt. %, about 1.0 wt. %, or about 5.0 wt. %, to a high of about 90.0 wt. %, about 95.0 wt. %, or about 99.9 wt. %. In another example, the reaction mixtures can have a content of the one or more acids from about 0.1 wt. % to about 99.9 wt. %, about 1.0 wt. % to about 99.0 wt. %, about 10.0 wt. % to about 90.0 wt. %, about 10.0 wt. % to about 20.0 wt. %, about 20.0 wt. % to about 30.0 wt. %, about 25.0 wt. % to about 75.0 wt. %, about 20.0 wt. % to about 80.0 wt. %, about 20.0 wt. % to about 30.0 wt. %, about 20.0 wt. % to about 60.0 wt. %, about 30.0 wt. % to about 40.0 wt. %, about 30.0 wt. % to about 70.0 wt. %, about 40.0 wt. % to about 60.0 wt. %, about 45.0 wt. % to about 55.0 wt. %, about 40.0 wt. % to about 50.0 wt. %, about 69.0 wt. % to about 75.0 wt. %, about 68.0 wt. % to about 82.0 wt. %, about 72.0 wt. % to about 86.0 wt. %, about 50.0 wt. % to about 73.0 wt. %, about 33.0 wt. % to about 48.0 wt. %, about 60.0 wt. % to about 70.0 wt. %, about 71.0 wt. % to about 81.0 wt. %, about 20.0 wt. % to 30.0 wt. %, about 50.0 wt. % to about 60.0 wt. %, or about 70.0 wt. % to about 80.0 wt. %. In another example, the one or more acids can include sulfuric acid and phosphoric acid in a ratio of about 12:1, about 10:1, about 9:1, about 8:1 about 7:1, or about 6:1. In another example, the reaction mixtures can be free of the one or more acids. The weight percent of the acid in the reaction mixtures can be based on the total weight of the reaction mixtures; or based on the total weight of the one or more polyethyleneimines, one or more graphene oxides, one or more acids, one or more bases, one or more salts, one or more solvents and/or carrier fluids, and the one or more additives.

The one or more bases can include, but are not limited to, sodium hydroxide, calcium hydroxide, potassium hydroxide, sodium phosphate, and combinations thereof.

The one or more reaction mixtures can have a content of the one or more bases that can vary widely. For example, the reaction mixtures can have a content of the one or more bases from a low of about 0.1 wt. %, about 1.0 wt. %, or about 5.0 wt. %, to a high of about 90.0 wt. %, about 95.0 wt. %, or about 99.9 wt. %. In another example, the reaction mixtures can have a content of the one or more bases from about 0.1 wt. % to about 99.9 wt. %, about 1.0 wt. % to about 99.0 wt. %, about 10.0 wt. % to about 90.0 wt. %, about 10.0 wt. % to about 20.0 wt. %, about 20.0 wt. % to about 30.0 wt. %, about 25.0 wt. % to about 75.0 wt. %, about 20.0 wt. % to about 80.0 wt. %, about 20.0 wt. % to about 30.0 wt. %, about 20.0 wt. % to about 60.0 wt. %, about 30.0 wt. % to about 40.0 wt. %, about 30.0 wt. % to about 70.0 wt. %, about 40.0 wt. % to about 60.0 wt. %, about 45.0 wt. % to about 55.0 wt. %, about 40.0 wt. % to about 50.0 wt. %, about 69.0 wt. % to about 75.0 wt. %, about 68.0 wt. % to about 82.0 wt. %, about 72.0 wt. % to about 86.0 wt. %, about 50.0 wt. % to about 73.0 wt. %, about 33.0 wt. % to about 48.0 wt. %, about 60.0 wt. % to about 70.0 wt. %, about 71.0 wt. % to about 81.0 wt. %, about 20.0 wt. % to 30.0 wt. %, about 50.0 wt. % to about 60.0 wt. %, or about 70.0 wt. % to about 80.0 wt. %. In another example, the reaction mixtures can be free of the one or more bases. The weight percent of the base in the reaction mixtures can be based on the total weight of the reaction mixtures; or based on the total weight of the one or more polyethyleneimines, one or more graphene oxides, one or more acids, one or more bases, one or more salts, one or more solvents and/or carrier fluids, and the one or more additives.

The pH of the one or more reaction mixtures can vary widely. For example, the one or more reaction mixtures can have a pH from about 4.0 to about 12.0, about 5.0 to about 10.0, about 7.5 to about 11.0, about 7.0 to about 10.0, about 8.0 to about 9.0, about 9.0 to about 10.0, about 8.0 to about 10.0, about 9.0 to about 11.0, or about 6.0 to about 9.0.

The one or more salts can include, but are not limited to: cesium formate, sodium chloride, sodium carbonate, sodium bicarbonate, potassium chloride, potassium carbonate, potassium bicarbonate, potassium fluoride, sodium fluoride, potassium formate, sodium formate, calcium chloride, ammonium carbonate, ammonium chloride, tetramethylammonium chloride, sodium chloride (NaCl), potassium chloride, and mixtures thereof.

The one or more reaction mixtures can have a content of the one or more salts that can vary widely. For example, the reaction mixtures can have a content of the one or more salts from a low of about 0.1 wt. %, about 1.0 wt. %, or about 5.0 wt. %, to a high of about 90.0 wt. %, about 95.0 wt. %, or about 99.9 wt. %. In another example, the reaction mixtures can have a content of the one or more salts from about 0.1 wt. % to about 99.9 wt. %, about 1.0 wt. % to about 99.0 wt. %, about 10.0 wt. % to about 90.0 wt. %, about 10.0 wt. % to about 20.0 wt. %, about 20.0 wt. % to about 30.0 wt. %, about 25.0 wt. % to about 75.0 wt. %, about 20.0 wt. % to about 80.0 wt. %, about 20.0 wt. % to about 30.0 wt. %, about 20.0 wt. % to about 60.0 wt. %, about 30.0 wt. % to about 40.0 wt. %, about 30.0 wt. % to about 70.0 wt. %, about 40.0 wt. % to about 60.0 wt. %, about 45.0 wt. % to about 55.0 wt. %, about 40.0 wt. % to about 50.0 wt. %, about 69.0 wt. % to about 75.0 wt. %, about 68.0 wt. % to about 82.0 wt. %, about 72.0 wt. % to about 86.0 wt. %, about 50.0 wt. % to about 73.0 wt. %, about 33.0 wt. % to about 48.0 wt. %, about 60.0 wt. % to about 70.0 wt. %, about 71.0 wt. % to about 81.0 wt. %, about 20.0 wt. % to 30.0 wt. %, about 50.0 wt. % to about 60.0 wt. %, or about 70.0 wt. % to about 80.0 wt. %. In another example, the reaction mixtures can be free of the one or more salts. The weight percent of the salts in the reaction mixtures can be based on the total weight of the reaction mixtures; or based on the total weight of the one or more polyethyleneimines, one or more graphene oxides, one or more acids, one or more bases, one or more salts, one or more solvents and/or carrier fluids, and the one or more additives.

The one or more reaction mixtures can be heated to a temperature from a low of about 0° C., about 15° C., and about 25° C., to a high of about 35° C., about 65° C., and about 100° C. For example, the one or more reaction mixtures can be heated to a temperature between about 25° C. to about 28° C., 25° C. to about 35° C., or 30° C. to about 45° C., 43° C. to about 78° C. In another example, reaction mixture can be at room temperature.

The one or more reaction mixtures can be reacted and/or stirred in an open reaction container or a closed container. The one or more reaction mixtures can be reacted and/or stirred under a vacuum. The one or more reaction mixtures can be reacted and/or stirred under an inert atmosphere, such as He, Ne, N₂, Ar.

The first reaction mixture, second reaction mixture, third reaction mixture, and more reaction mixtures can be reacted and/or stirred for a first reaction time, second reaction time, third reaction time, and higher iterations of reaction times from a short of about 15 s, about 120 s, or about 300 s, to a long of about 1 h, about 24 h, or about 72 h. For example, the first reaction mixture, second reaction mixture, third reaction mixture, and higher iterations of reaction mixtures can be reacted and/or stirred for a first reaction time, second reaction time, third reaction time, and higher iterations of reaction times can be from about 1 min to about 15 min, about 5 min to about 45 min, about 1 h to about 12 h, about 5 h to about 15 h, about 14 h to about 16 h, about 15 h to about 16 h, about 10 hours to about 24 hours, about 12 h to about 17 h, about 12 h to about 24 h, about 22 h to about 50 h, or about 24 h to about 72 h.

The first reaction mixture, second reaction mixture, third reaction mixture, and higher iterations of reaction mixtures can be heated to a temperature from a low of about 0° C., about 15° C., and about 25° C., to a high of about 35° C., about 65° C., and about 200° C. For example, the first reaction mixture, second reaction mixture, third reaction mixture, and higher iterations of reaction mixtures can be heated to a temperature from about 25° C. to about 28° C., about 25° C. to about 35° C., about 25° C. to about 90° C., about 30° C. to about 45° C., about 45° C. to about 55° C., about 40° C. to about 90° C., about 43° C. to about 78° C., about 40° C. to about 90° C., about 100° C. to about 200° C. In another example, the first reaction mixture, second reaction mixture, third reaction mixture, and higher iterations of reaction mixtures can be at room temperature. In another example, the reaction occurs at a temperature of greater than about 40° C. or greater than about 50° C. The first reaction mixture, second reaction mixture, third reaction mixture, and higher iterations and reaction mixtures can be performed at different temperatures.

The one or more reactions mixtures for making the polyethyleneimine modified graphene oxide can have a viscosity that varies widely. For example, the one or more reactions mixtures can have a viscosity from a low of about 1 cP, about 10 cP, or about 1,000 cP, to a high of about 25,000 cP, about 90,000 cP, or about 250,000 cP. In another example, the reactions mixtures can have a viscosity from about 1 cP to about 250,000 cP, about 2 cP to about 100 cP, about 25 cP to about 2,500 cP, about 2,500 cP to about 200,000 cP, about 10,000 cP to about 100,000 cP, about 10,000 cP to about 50,000 cP, about 100,000 cP to about 250,000 cP, about 6000 cP to about 85,000 cP, about 7,000 cP to about 75,000 cP, about 7,000 cP to about 80,000 cP, about 5,000 cP to about 10,000 cP, or about 50,000 cP to about 200,000 cP. The viscosity of the reaction mixtures can be measured on a Brookfield viscosimeter. The viscosity of the reaction mixtures can be measured at various temperatures, such as 25° C., 40° C., 60° C., and 100° C.

In one or more embodiments, the method of using a polyethyleneimine modified graphene oxide can include, but are not limited to: contacting one or more polyethyleneimine modified graphene oxide with one or more solvents and, optionally one or more additives to make one or more polyethyleneimine modified graphene oxide compositions; contacting the one or more polyethyleneimine modified graphene oxide compositions with an aqueous mixture containing one or more contaminants to reduce the concentration of the one or more contaminants in the aqueous mixture. In another embodiment, the spent polyethyleneimine modified graphene oxide of the polyethyleneimine modified graphene oxide composition can be recharged by contacting with an, alcohol, such as isopropyl alcohol.

The one or more polyethyleneimine modified graphene oxide compositions can include, but are not limited to: one or more polyethyleneimine modified graphene oxides, one or more solvents or carrier fluids, one or more acids, one or more bases, one or more salts, and one or more additives. The one or more polyethyleneimine modified graphene oxide compositions can have a content of the one or more polyethyleneimine modified graphene oxide that can vary widely. For example, the polyethyleneimine modified graphene oxide composition can have a polyethyleneimine modified graphene oxide content from a low of about 0.1 wt %, about 5 wt %, or about 30 wt %, to a high of about 70 wt %, about 80 wt %, or about 95 wt %. In another example, the polyethyleneimine modified graphene oxide composition can have a polyethyleneimine modified graphene oxide content of at least 15 wt %, at least 10 wt %, or at least 25 wt %. In another example, the polyethyleneimine modified graphene oxide composition can have a polyethyleneimine modified graphene oxide content from about 5 wt % to about 95 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the graphene oxide in the polyethyleneimine modified graphene oxide can be based on the total weight of the polyethyleneimine modified graphene oxide; or based on the total weight of the one or more polyethyleneimines, one or more graphene oxides, one or more acids, one or more bases, one or more salts, one or more solvents and/or carrier fluids, and the one or more additives.

The one or more solvents and/or carrier fluids of the polyethyleneimine modified graphene oxide compositions can include, but are not limited to: aliphatic hydrocarbons, such as hexanes; aromatic hydrocarbons, such as toluene and benzene; water; deionized water; methanol; ethanol; propanol; isopropanol; acetone; acetonitrile; chloroform; diethyl ether; methylene chloride; dimethyl formamide; ethylene glycol; propylene glycol; triethylamine; tetrahydrofuran; and mixtures thereof.

The one or more polyethyleneimine modified graphene oxide compositions can have a content of the solvents and/or carrier fluids that can vary widely. For example, the polyethyleneimine modified graphene oxide compositions can have a content of the solvents and/or carrier fluids from a low of about 0.1 wt %, about 0.5 wt %, or about 1 wt %, to a high of about 50 wt %, about 70 wt %, or about 99.9 wt %. In another example, the polyethyleneimine modified graphene oxide compositions can have content of the solvents and/or carrier fluids from about 0.1 wt % to about 99.9 wt %, 0.2 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 19 wt % to about 27 wt %, about 15 wt % to about 27 wt %, about 14 wt % to about 24 wt %, about 11 wt % to about 28 wt %, about 33 wt % to about 48 wt %, about 51 wt % to about 54 wt %, or about 50 wt % to about 60 wt %. The weight percent of the content of the solvents and/or carrier fluids in the polyethyleneimine modified graphene oxide compositions can based on the total weight of the polyethyleneimine modified graphene oxide compositions, or based on the total weight of the one or more polyethyleneimines, one or more graphene oxides, one or more acids, one or more bases, one or more salts, one or more solvents and/or carrier fluids, and the one or more additives.

The one or more polyethyleneimine modified graphene oxide compositions can have a content of the one or more additives that can vary widely. For example, the polyethyleneimine modified graphene oxide compositions can have a content of the one or more additives from a low of about 0.1 wt %, about 0.5 wt %, or about 1 wt %, to a high of about 50 wt %, about 70 wt %, or about 90 wt %. In another example, the polyethyleneimine modified graphene oxide compositions can have content of the one or more additives from about 0.1 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 19 wt % to about 27 wt %, about 15 wt % to about 27 wt %, about 14 wt % to about 24 wt %, about 11 wt % to about 28 wt %, about 33 wt % to about 48 wt %, about 51 wt % to about 54 wt %, or about 50 wt % to about 60 wt %. The weight percent of the based on the total weight of the polyethyleneimine modified graphene oxide compositions, or based on the total weight of the one or more polyethyleneimines, one or more graphene oxides, one or more acids, one or more bases, one or more salts, one or more solvents and/or carrier fluids, and the one or more additives.

The one or more polyethyleneimine modified graphene oxide compositions can include a chemical oxidizers The chemical oxidizer can improve the surface chemistry of the resulting adsorbent. The one or more additives can include, but are not limited to: one or more chemical oxidizers, ozone, hydrogen peroxide, and mixtures thereof.

The one or more polyethyleneimine modified graphene oxide compositions can have a viscosity that varies widely. For example, the polyethyleneimine modified graphene oxide compositions can have a viscosity from a low of about 1 cP, about 10 cP, or about 1,000 cP, to a high of about 25,000 cP, about 90,000 cP, or about 250,000 cP. In another example, the polyethyleneimine modified graphene oxide compositions can have a viscosity from about 1 cP to about 250,000 cP, about 2 cP to about 100 cP, about 25 cP to about 2,500 cP, about 2,500 cP to about 200,000 cP, about 10,000 cP to about 100,000 cP, about 10,000 cP to about 50,000 cP, about 100,000 cP to about 250,000 cP, about 6000 cP to about 85,000 cP, about 7,000 cP to about 75,000 cP, about 7,000 cP to about 80,000 cP, about 5,000 cP to about 10,000 cP, or about 50,000 cP to about 200,000 cP. The viscosity of the polyethyleneimine modified graphene oxide compositions can be measured on a Brookfield viscosimeter. The viscosity of the polyethyleneimine modified graphene oxide compositions can be measured at various temperatures, such as 25° C., 40° C., 60° C., and 100° C.

The one or more contaminants can include, but are not limited to: perfluoroalkyl compounds, polyfluoroalkyl compounds, perfluorooctanoic acids, perfluorooctane sulfonates, and mixtures thereof. The concentration of the contaminant in the aqueous mixture can be reduced by the polyethyleneimine modified graphene oxide composition from a low of about 1 wt %, about 2 wt %, or about 5 wt %, to a high of about 40 wt %, about 60 wt % or about 99 wt %. For example, the concentration of the contaminant in the aqueous mixture can be reduced by the polyethyleneimine modified graphene oxide composition from about 1 wt % to about 99 wt %, about 1 wt % to about 10 wt %, about 2 wt % to about 20 wt %, about 5 wt % to about 30 wt %, about 10 wt % to about 60 wt %, about 15 wt % to about 85 wt %, about 35 wt % to about 95 wt %, about 45 wt % to about 55 wt %, or about 45 wt % to about 92 wt %.

The pH of the one or more polyethyleneimine modified graphene oxide compositions can vary widely. For example, the one or more polyethyleneimine modified graphene oxide compositions can have a pH from about 4.0 to about 12.0, about 5.0 to about 10.0, about 7.5 to about 11.0, about 7.0 to about 10.0, about 8.0 to about 9.0, about 9.0 to about 10.0, about 8.0 to about 10.0, about 9.0 to about 11.0, or about 6.0 to about 9.0.

PFOA molecule exists as a negatively charged anion in the wastewater due to its low pKₐ value of −0.20. Without wanting to be bound by theory, it is believed that the positively charged adsorbents significantly promote PFAS uptake through electrostatic attraction. Nitrogen-containing adsorbents can have a promising ability in PFAS adsorption since the amide and amine groups in these adsorbents could be protonated and become positively charged thus, attracting PFAS, such as PFOA anions. However, some adsorbents showed poor stability during the kinetic study due to their ineffective design or preparation. For example, magnetic core-shell aminosilane nanocomposite was used in adsorbing PFOA from synthetic wastewater but the loss of amine groups from the adsorbent was observed during the PFOA adsorption process, causing an in-situ adsorption-desorption problem. Unstable adsorption also occurred in adsorbing the representative PFAS compound, PFOA, onto covalent organic frameworks due to the detachment of amine groups which can become another pollutant and increase the burden of wastewater treatment. Therefore, a nitrogen-containing adsorbent with good stability is crucial in PFOA removal. In recent years, the application of polyethyleneimine (PEI) has received extensive attention in wastewater treatment due to abundant amine groups in PEI molecular, which can react with various compounds through hydrogen bonding and electrostatic attractions. In order to stabilize the PEI onto the non-soluble base for PFOA adsorption from aqueous solutions, graphene oxide (GO) was utilized as an ideal substrate because it contains sufficient randomly distributed carboxyl groups (—COOH) at its edges or surfaces. These carboxyl groups (—COOH) can form a huge number of amide bonds with the amines from PEI making PEI modified graphene oxide (GO-PEI) a stable adsorbent that shows excellent performance in PFOA adsorption.

PFOA contains hydrophobic tail that could lead to multilayer aggregation at high concentrations wherein multilayer structures might be formed after the first layer's maximum coverage. Up to now, Freundlich isotherm model is the most used isotherm model which describes the multilayer PFOA adsorption. However, Freundlich isotherm model failed to evaluate the maximum monolayer PFOA adsorption capacity since it is just an empirical equation. To evaluate the maximum monolayer PFOA adsorption capacity, the most appropriate isotherm model should be used in the isotherm study. Compared with the Freundlich isotherm model, the Brunauer-Emmett-Teller (BET) model assumes that the adsorption energy in the first layer is different from the other layers in the liquid-solid systems. Therefore, BET isotherm model is considered a special combination of monolayer and multilayer isotherm model thus the maximum amount of monolayer adsorption could be evaluated successfully.

### EXAMPLES

To provide a better understanding of the foregoing discussion, the following non-limiting examples are offered. Although the examples can be directed to specific embodiments, they are not to be viewed as limiting the invention in any specific respect.

Perfluorooctanoic acid was used as the example PFAS compound; however other polyfluoroalkyl substances compounds would perform similarly. The adsorption behaviors and mechanisms of perfluorooctanoic acid onto polyethyleneimine modified graphene oxide (GO-PEI) from aqueous solutions was evaluated. It was shown that the adsorption capacity was significantly improved by doping polyethyleneimine (PEI) onto graphene oxide (GO). The Brunauer-Emmett-Teller (BET) isotherm model was considered as the best isotherm model in describing the PFOA adsorption onto polyethyleneimine modified graphene oxide (wPEI/wGO=3), polyethyleneimine modified graphene oxide exhibited high adsorption capacity (qₑ=368.2 mg/g, calculated from BET isotherm model) and excellent stability. The maximum monolayer amount of PFOA adsorption onto polyethyleneimine modified graphene oxide (qₘ=231.2 mg/g) was successfully evaluated. The calculated saturated concentration (Cₛ=169.9 mg/L) of PFOA on GO-PEI3 closely agrees with its critical micelle concentration (CMC=157.0 mg/L), suggesting the formation of multilayer hemi-micelles or micelles PFOA structures on the surface of GO-PEI3. PFOA adsorption onto GO-PEI3 was inhibited by several factors including: the presence of humic acid (HA) by competing with the adsorption sites, background salts through the double-layer compression effect, and the competition from soluble ions for the amine or amide functional groups on GO-PEI3. Finally, both the FT-IR and XPS results confirmed that the adsorption of PFOA onto GO-PEI3 was through electrostatic attraction and hydrophobic interaction (physical adsorption), but not chemical adsorption. This work provides fundamental knowledge both in understanding the adsorption behavior through the BET isotherm model and in developing a stable adsorbent for PFOA adsorption. In addition, the findings highlight the potential of PFOA remediation from wastewater systems using polyethyleneimine modified graphene oxide in engineering applications.

### Materials and Methods

Graphite flakes (100 mesh), isopropyl alcohol (IPA, 70%), hydrogen peroxide (H₂O₂, 30%), and sodium hydroxide (NaOH, 99%+) were purchased from Sigma Aldrich, St. Louis, USA. Potassium permanganate (KMnO₄, 99+%) and sulfuric acid (H₂SO₄, 95.0%-98.0%) were obtained from VWR Scientific Missouri, USA. Phosphoric acid (H₃PO₄, 85%), hydrochloric acid (HCl, 37%), and polyethyleneimine (MW=800) were acquired from Acros Organics, New Jersey, USA. Humic acid (HA), nitric acid (HNO₃, 90%), sodium chloride (NaCl, 99%), potassium chloride (KCl, 99%), calcium chloride (CaCl₂, 99.99%), magnesium chloride hexahydrate (MgCl₂·6H₂O, 99%), sodium nitrate (NaNO₃, 98%), sodium fluoride (NaF, 99%), and sodium sulfate (Na₂SO₄, 99%) were procured from Fisher Scientific, Waltham, USA.

### Fabrication of Graphene Oxide and Polyethyleneimine Modified Graphene Oxide

Graphene oxide was synthesized from graphite flakes using modified Hummers' Method. First, the concentrated H₂SO₄/H₃PO₄ (360:40 mL) mixture was added to a three-neck flask containing 3 g graphite flakes. Constant stirring of the mixture was done at 10° C. or lower in an ice bath. Eighteen grams of KMnO₄ was gradually added into the mixture and heated to 50° C. with stirring for 15 h in a water bath. After the reaction, the resulting graphite oxide was poured into a beaker containing 400 mL ice, then 5 mL H₂O₂ was added with an observed color change from purple to yellow. Then the graphite oxide was cooled to 25° C. and washed with 500 mL of 10% HCl. Lastly, the graphite oxide was exfoliated by ultrasound (Kendal HB-S-36 MHT), continuously washed with deionized (DI) water and centrifuged (Thermo D-37520 Osterode) until it reached a neutral pH. The resulting graphene oxide was freeze-dried (Labconco Freezone 6 Plus Freeze Drier) for 48 h then ground into powder (SPEX 8000 M Mixer/Mill) for the succeeding modification.

The polyethyleneimine modified graphene oxide adsorbent was prepared by dispersing 100 mg of graphene oxide powder into 100 mL of DI water with ultrasonication for 30 min, followed by adding 100 mL of a certain concentration of PEI solution into the graphene oxide solution. After stirring at 25° C. for 24 h, the mixture was washed to neutral pH using deionized water, then dried in an oven at 50° C. for 24 h. Finally, the polyethyleneimine modified graphene oxide adsorbent was obtained by grinding the dry sample into powder. The different PEI loadings (wPEI/wGO=0.5, 1, 2, 3, 4) of polyethyleneimine modified graphene oxide were prepared separately and the final adsorbents were named as GO-PEIx (mass ratio x=0.5, 1, 2, 3, 4, respectively).

### Characterization of Graphene Oxide and Polyethyleneimine Modified Graphene Oxide

Vario Elementar Organic Elemental Analyzer (Elementar Americas) was used to determine the adsorbents' elemental composition (C, H, O, N, and S). X-ray powder diffraction (XRD, Rigaku MiniFlex Benchtop X-ray Diffractometer) patterns were obtained to compare the structural differences between graphene oxide and GO-PEI. The functional groups of adsorbents before and after adsorption were identified via Fourier-transform infrared spectroscopy (FT-IR, Bruker VERTEX 70v Spectrometer). X-ray photoelectron spectroscopy (XPS, ESCA 2 SR XPS system) was performed to verify the elemental composition and valence of adsorbents before and after adsorption. The surface area and pore volume distribution of samples were measured in the N₂ adsorption-desorption (Micromeritics ASAP, 2020) instrument. Scanning electron microscope (SEM, JEOL 6300 Field Emission Scanning Electron Microscope, 15 kV) was used to observe the morphology of graphene oxide and GO-PEI. The point of zero charge (pH_{pze}) of graphene oxide and polyethyleneimine modified graphene oxide was evaluated using the potentiometric titration method.

### Batch Adsorption Experiments

The adsorption capacity of PFOA onto polyethyleneimine modified graphene oxide was evaluated through batch adsorption experiments. All sorption experiments were carried out in 250-mL conical flasks mounted on a constant temperature (25° C.) rotary shaker (New Brunswick Scientific Edison EXCELLA E24R) at 200 rpm to simulate a homogeneous system for 15 h. Ten milligrams of each adsorbent were added into 100 mL of PFOA solution with an initial pH=4.0 and PFOA concentration of 50 mg/L (unless specified). Adsorption isotherm data were constructed by varying the initial PFOA concentration ranging from 10 to 100 mg/L. The initial pH effects on adsorption performance were conducted within the pH range of 4.0-10.0, adjusted using 50 mM NaOH and HCl solutions. Different salts in PFOA aqueous solutions were tested for both anions (10 mM Na₂SO₄, NaNO₃, NaF, and NaCl) and cations (10 mM of CaCl₂), KCl, MgCl₂, and NaCl) to evaluate the effect of background ions on PFOA adsorption. The influence of varying HA concentrations (0-30 mg/L) on PFOA adsorption was also assessed. Equation 1 was used to calculate the adsorption capacity of PFOA onto GO-PEI:

$${q}_{e} = \frac{( {C}_{0} - {C}_{e} ) \times V}{M} , \qquad ( 1 )$$

where qₑ (mg/g) is the equilibrium adsorption capacity, C₀ (mg/L) is the initial concentration of PFOA, Cₑ (mg/L) is the residual concentration of PFOA, V (L) is the volume of the solution, and M (g) is the mass of GO-PEI.

### Desorption and Reuse

The spent polyethyleneimine modified graphene oxide was filtered out using 0.45 μm cellulose ester membrane (Whatman) filter paper. Different concentrations of isopropyl alcohol (IPA) solutions (0-40 vol %) were used as desorption reagents to regenerate the spent polyethyleneimine modified graphene oxide. The spent polyethyleneimine modified graphene oxide and 100 mL desorption reagent were mixed then put in a shaker with an agitation speed of 200 rpm for 15 h at 25° C. The regenerated polyethyleneimine modified graphene oxide was filtered out and dried in the oven at 50° C. for 15 h. Five adsorption-desorption sequential cycles were conducted to evaluate the reusability of the polyethyleneimine modified graphene oxide.

### PFOA Determination

Samples (1 mL) were obtained at predetermined sampling times and filtered through a 0.45 μm membrane filter. Filtrate dilution was done to analyze the remaining PFOA in the aqueous phase. The effect of the filter membrane on PFOA was eliminated due to its low rejection rate. Analyses of the samples were accomplished via liquid chromatography-mass spectrometry (LC/MS). PFOA concentrations were quantified by injecting 20 μL of the sample into an HP Agilent 1100 high-performance liquid chromatography (HPLC) for separation with a Phenomenex Kinetex C18 column (100×4.6 mm, 2.6 μm particle size) equipped with guard cartridge system. The solvent system used was a mixture of 50 mM ammonium acetate and acetonitrile (60/40) maintained at 0.6 mL/min flow rate. The chromatograms were analyzed by an Agilent 6340 Ion Trap (MS step) in negative mode testing for the decarboxylated perfluorooctanoate (m/z=369). Parameters were as follows: drying gas temperature 360° C., drying gas flow rate 6 L/min, nebulizer pressure 30 PSI, capillary and skimmer voltages at +3500 V and −40 V, respectively.

### Characterization of Graphene Oxide and Polyethyleneimine Modified Graphene Oxide

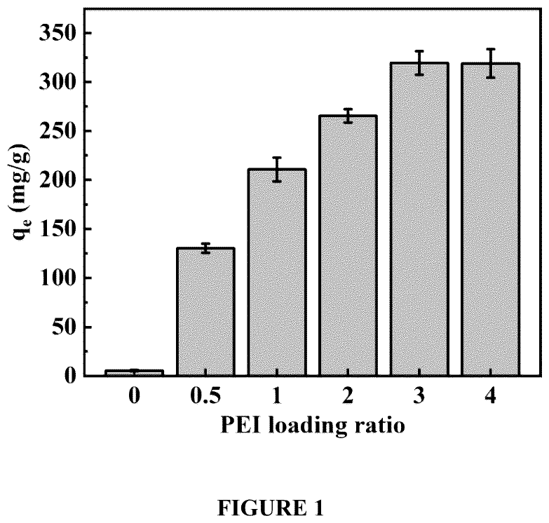

Table 1 tabulates the elemental composition of the adsorbents. The effect of increasing PEI loading ratio on graphene oxide was evaluated. The N-content in GO-PEIx increased dramatically at the beginning. But once the graphene oxide to PEI ratio reached 1:3 (w/w), only a slight increase in N-content was observed in GO-PEIx. As shown in FIG. 1, PFOA uptake increases with the increase in N-content from the PEI loading but only to a certain amount. When the N-content reached its upper limit through PEI modification in GO-PEI3, the adsorption capacity of PFOA also achieved its maximum. All remaining experiments used GO-PEI3 as adsorbent since it exhibited the highest adsorption capacity for PFOA removal.

TABLE 1
Elemental composition of adsorbents
at different PEI loading ratios on GO

| | PEI loading | | | | | | |
|---|---|---|---|---|---|---|---|
| Sample | (w/w) | N % | C % | H % | S % | O % | N/C % |
| GO | 0 | 0.00 | 39.45 | 2.51 | 0.041 | 58.00 | 0.00 |
| GO-PEI0.5 | 0.5 | 8.55 | 48.21 | 4.37 | 0.034 | 38.83 | 17.73 |
| GO-PEI1 | 1 | 9.73 | 48.65 | 4.65 | 0.037 | 36.99 | 20.00 |
| GO-PEI2 | 2 | 10.40 | 48.72 | 4.81 | 0.084 | 35.98 | 21.34 |
| GO-PEI3 | 3 | 10.93 | 48.75 | 4.84 | 0.025 | 35.45 | 22.42 |
| GO-PEI4 | 4 | 11.10 | 49.59 | 4.94 | 0.023 | 34.34 | 22.38 |

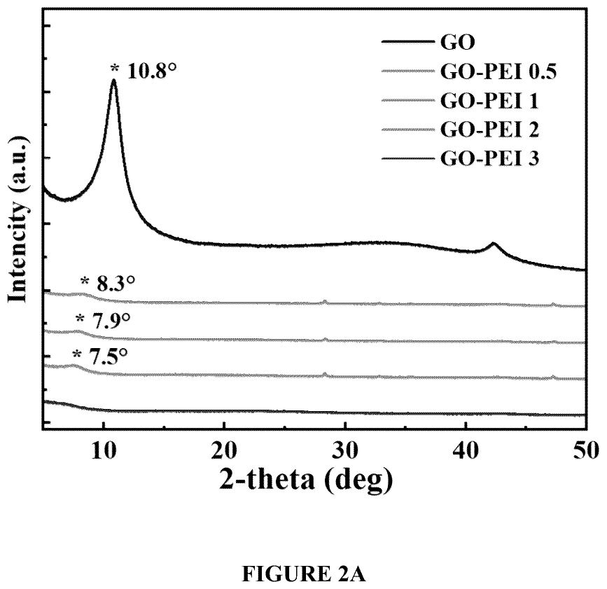

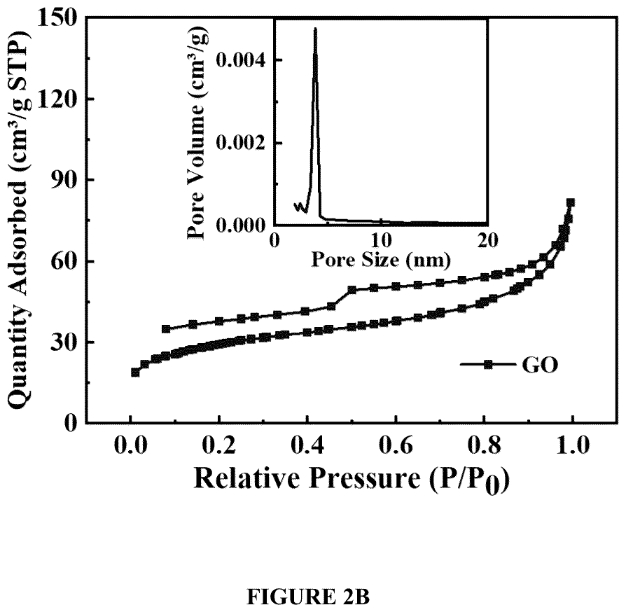

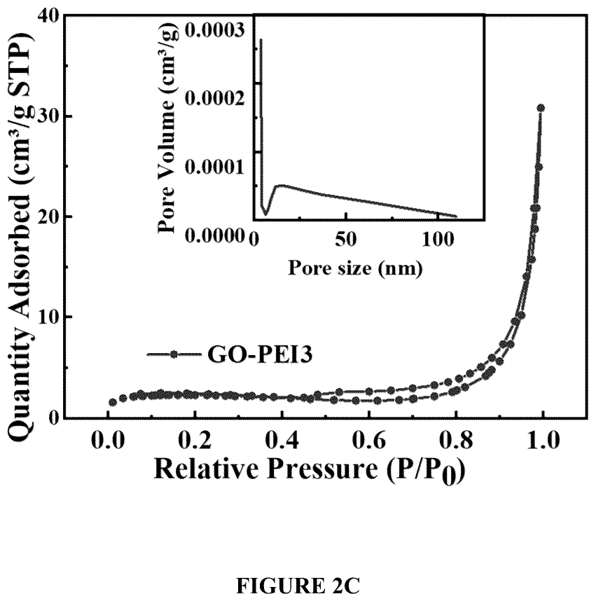

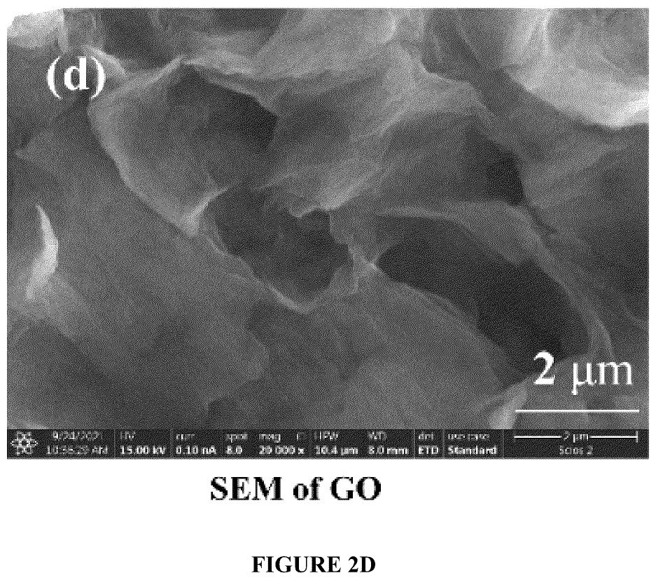

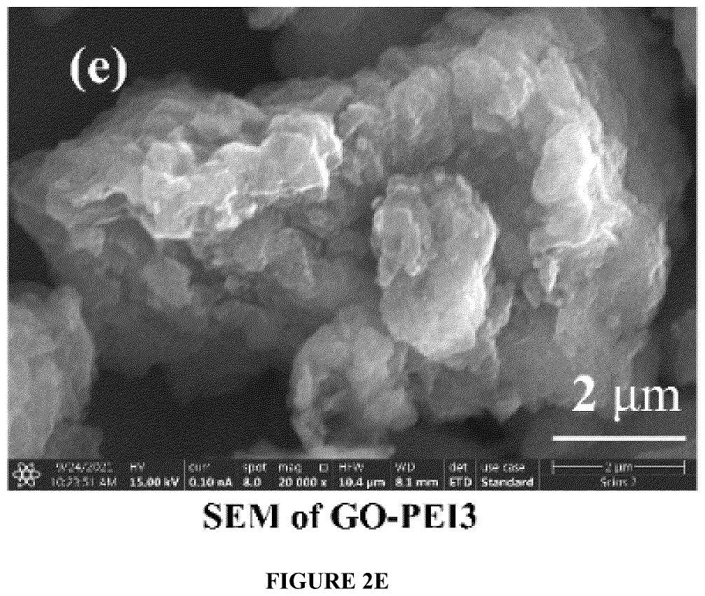

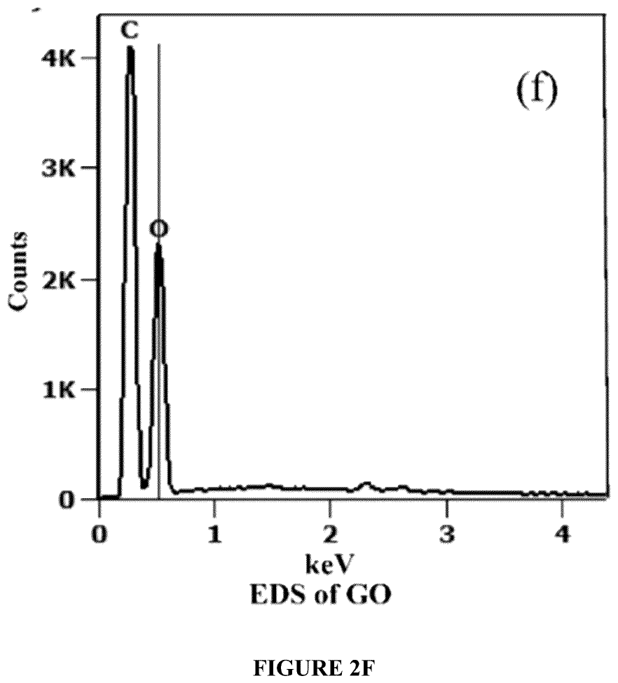

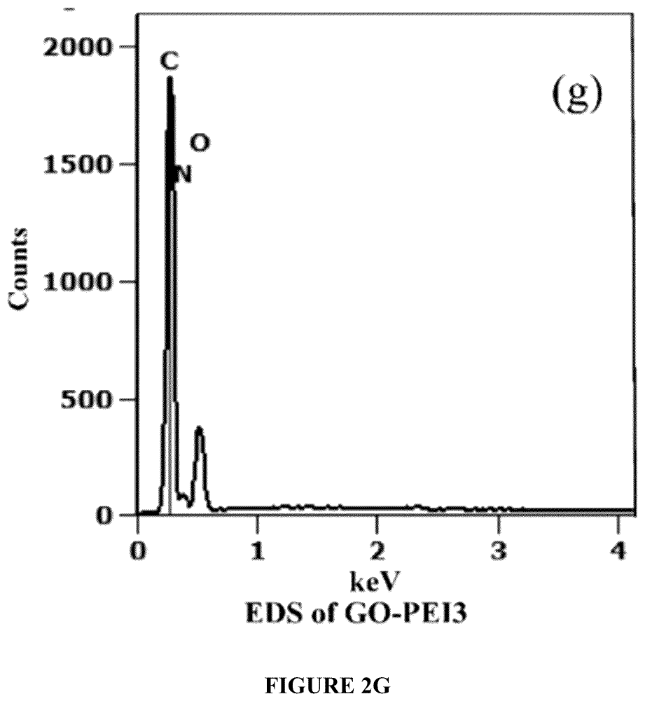

XRD was used to identify the differences in crystalline phases between graphene oxide and GO-PEIx (FIG. 2A). The graphene oxide powder showed an intense feature diffraction peak at 2θ=10.8° which corresponds to the d-spacing of 8.17 Å, indicating the presence of water trapped between graphene oxide layers and oxygen-rich groups on layer edges. Compared with graphene oxide, the peak at 10.8° disappeared and formed into new peaks at 8.3°, 7.9°, and 7.5° corresponding to GO-PEI0.5, GO-PEI1, and GO-PEI2, respectively. As the PEI loading ratios increased, the XRD peak location of polyethyleneimine modified graphene oxide shifted to the left, showing the interlayer spacing expansion by PEI intercalation. Moreover, the XRD peak intensities of GO-PEIx were much lower than the graphene oxide, suggesting that most of the graphene oxide sheets were exfoliated by the sonication process. No XRD peak was detected on GO-PEI3 after further increasing the PEI loading ratio, which means that stacking graphene oxide sheets were distorted by PEI and formed a disordered structure.

The specific surface area and pore volume distribution of samples were tested by N₂ adsorption-desorption isotherms. FIG. 2B shows a mix of Type II and IV isotherms for graphene oxide indicating the presence of mesopores on graphene oxide. The Type H4 hysteresis loop of graphene oxide revealed the presence of capillary condensation. The open hysteresis demonstrated that part of the absorbed N₂ cannot be desorbed from the narrow/constricted micropore network. The N₂ adsorption-desorption of GO-PEI3 showed a mix of Type II and V isotherms (FIG. 2C) which could be associated to the relatively weak interactions between GO-PEI3 and N₂. The texture parameters showed that graphene oxide has a specific surface area of 263.77 m²/g with an average pore volume of 0.1385 cm³/g. After PEI modification, GO-PEI3 has a specific surface area of 7.96 m²/g with an average pore volume of 0.0479 cm³/g. GO-PEI3 exhibited a smaller specific surface area and less pore volume. This observed reduction could be attributed to the filling of graphene oxide layers spacing by PEI polymers and the small sheets of the graphene oxide were cross-linked into a less-porous cluster.

SEM images of graphene oxide presented a typical layered and wrinkled surface (FIG. 2D). After modification with PEI, the porous structure of graphene oxide was reformed into an irregular solid surface due to aggregation (FIG. 2E) which agrees with the BET textural analysis results. Additionally, the detection of nitrogen on GO-PEI3 by energy dispersive spectroscopy (EDS) (FIGS. 2F and 2G) further confirmed that the PEI was successfully loaded onto graphene oxide.

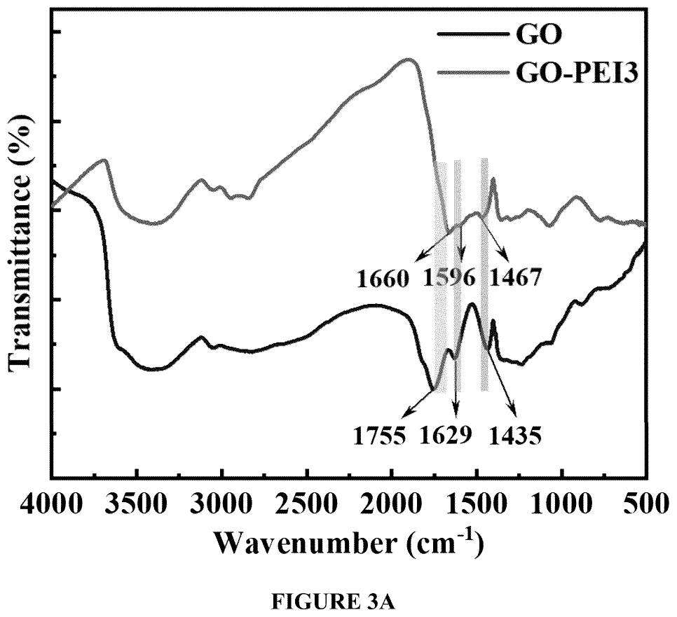

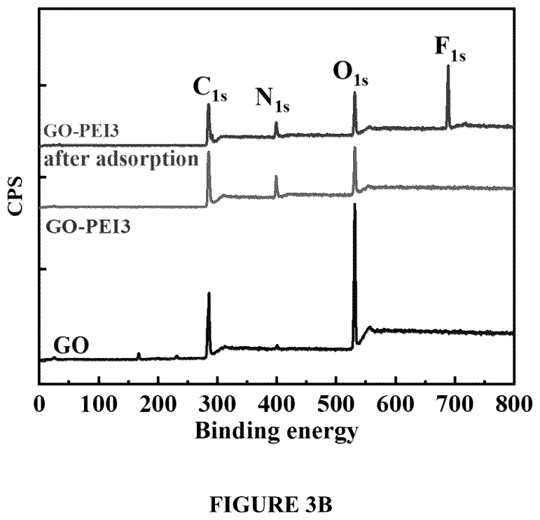

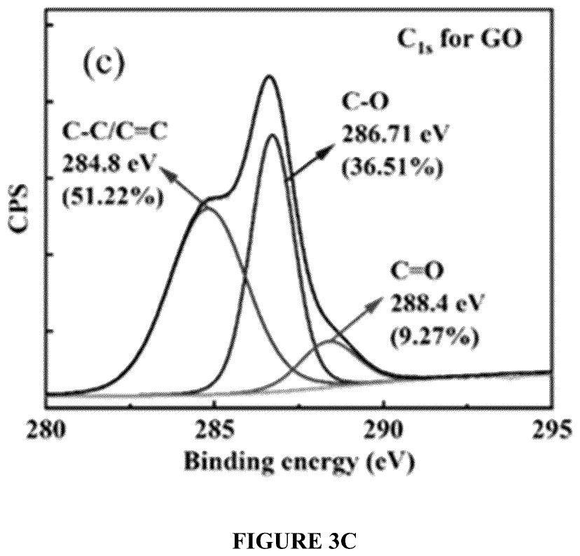

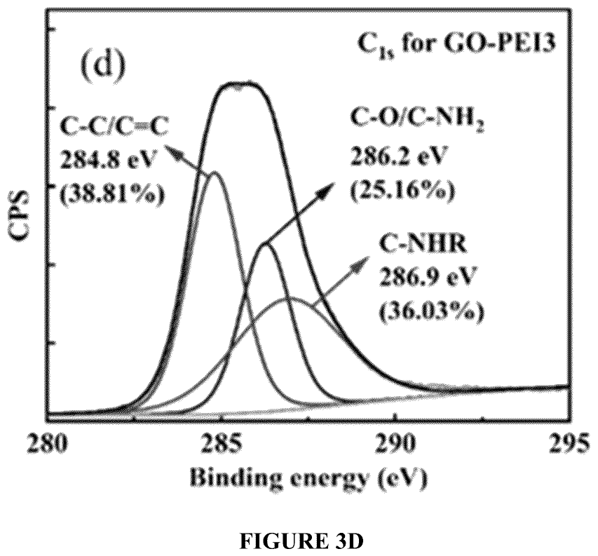

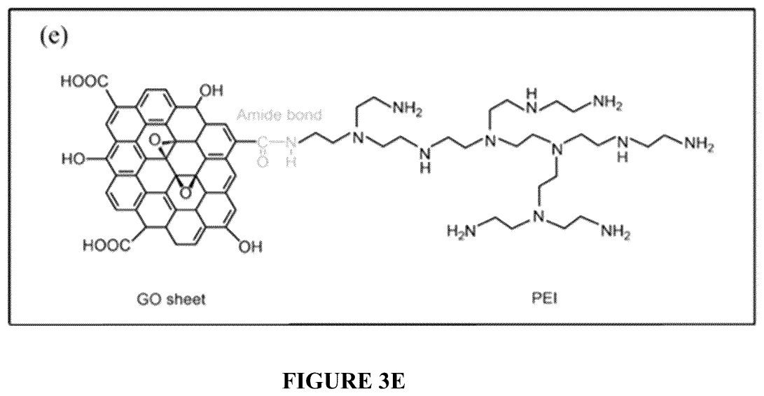

The FT-IR spectrum of graphene oxide showed the presence of oxygen-containing groups (FIG. 3A). The bands at 1755 and 1435 cm 1 were contributed to the vibration of C═O in carboxyl group (—COOH) and C—O—H bending of phenolic groups, respectively. Compared with graphene oxide, the observed stretching vibration at 1755 cm 1 completely disappeared in the GO-PEI3 spectrum which can be due to the conversion of-COOH group, signifying that most carboxyl group was likely converted into other functional groups. Three new peaks were observed at 1660, 1596, and 1435 cm⁻¹ in the GO-PEI3 spectrum that could be related to the asymmetric stretching of amide (—CONH), N—H, and C—N, respectively. This implies that the PEI was successfully grafted onto graphene oxide. FIG. 3E illustrates the amide bond present in GO-PEI3.

The XPS survey spectrum revealed the presence of nitrogen in GO-PEI3 and fluorine in spent GO-PEI3 (FIG. 3B) suggesting that the graphene oxide was modified by PEI and PFOA was successfully adsorbed onto GO-PEI3. After PEI modification, the C═O peak at 288.4 eV disappeared with the appearance of two new peaks: C—NHR at 286.9 eV and C—NH₂ at 286.2 eV (FIGS. 3C and 3D). These peaks denote the chemical reaction between carboxyl groups in graphene oxide and amine groups in PEI (FIG. 3E) which conforms with the FT-IR results in FIG. 3A.

### Influence of Initial Solution pH

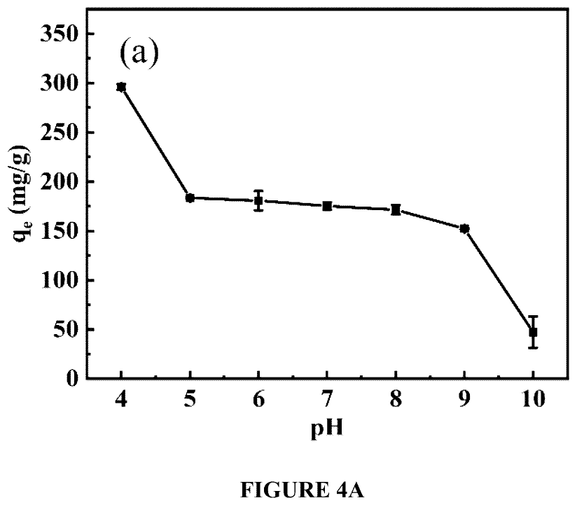

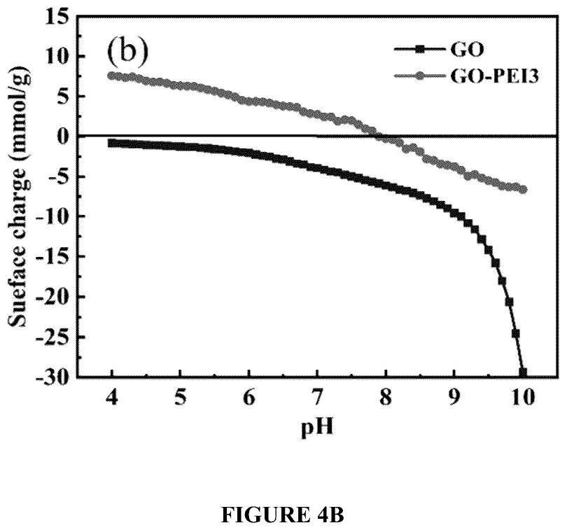

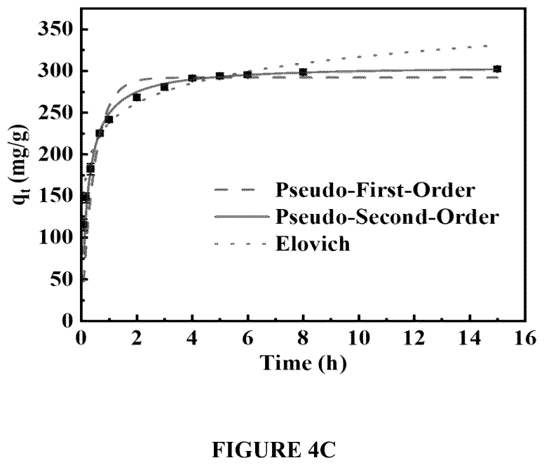

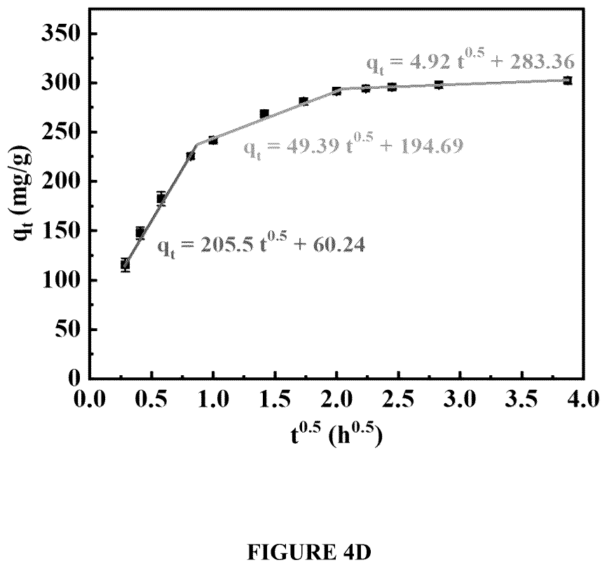

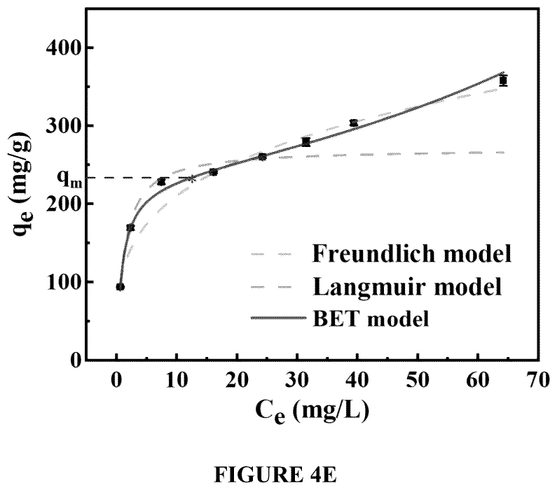

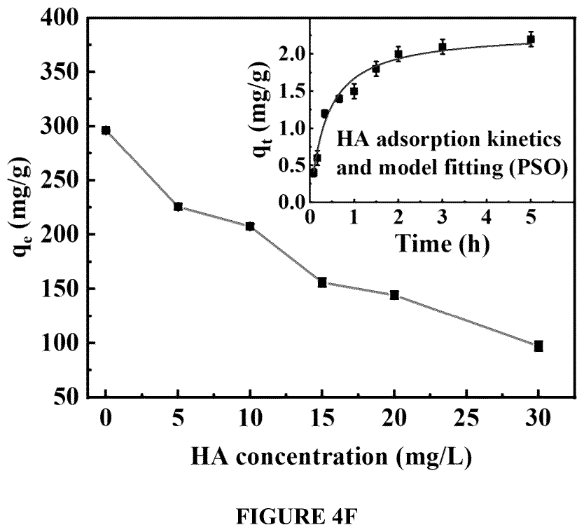

pH value is an essential factor that can influence the speciation of adsorbents and adsorbates. Hence, the adsorption efficiencies of PFOA onto the GO-PEI3 were explored under different pH values (FIG. 4A). The PFOA adsorption capacity was high at low pH and decreased with the rise in pH. The PFOA adsorption capacity at pH 10.0 was only around 14% of the capacity exhibited at pH 4.0. This phenomenon was mainly attributed to the charge differences of GO-PEI3 under different pH conditions. According to the surface charge results shown in FIG. 4B, the point of zero charge of GO-PEI3 was found at pH 7.9 specifying that the nitrogen-containing functional groups on GO-PEI3 was deprotonated and became negatively charged when the pH was above 7.9. Also, the electrostatic repulsion would appear between both negatively charged GO-PEI3 and PFOA anions. However, it was observed that the negatively charged GO-PEI3 still has adsorption capacity for PFOA anions. This suggests that another mechanism was playing an essential role in PFOA adsorption. PFOA displays hydrophobicity since it has a long hydrophobic carbon-fluoride tail. The hydrophobic interaction between PFOA and GO-PEI3 could overcome the electrostatic repulsion that aided the adsorption of PFOA.

The results from FIG. 4A shows the huge potential of GO-PEI3 as an excellent adsorbent for wastewaters with low pH. The lowest pH of electronics manufacturing wastewater and PFOA production wastewater is around 4.0, and the highest adsorption capacity of PFOA onto GO-PEI3 was achieved at this pH. Thus, the remainder of the adsorption experiments were conducted at pH 4.0 to maintain the best adsorption performance.

### Adsorption Kinetic Experiment

FIG. 4C presents the kinetic data of PFOA adsorption onto GO-PEI3. The amount of PFOA adsorbed increased rapidly during the first hour and reached adsorption equilibrium within 5 h. Most importantly, no in-situ adsorption-desorption was observed during the kinetics study meaning GO-PEI3 has good stability in PFOA adsorption. Different kinetic models were investigated to better understand the adsorption kinetic behaviors. Experimental data were fitted in the pseudo-first-order (PFO) (Equation 2) and pseudo-second-order (PSO) (Equation 3) equations to estimate the adsorption process and equilibrium time. The Elovich model (Equation 4) was used to establish the adsorption mechanism, while the Weber and Morris Intraparticle diffusion (Equation 5) model was applied to describe the intraparticle diffusion process. The equation are as follows:

$$PFO : {q}_{t} = {q}_{e} [ 1 - exp ( - {k}_{1} t ) ] ; \qquad ( 2 )$$

$$PSO : {q}_{t} = {q}_{e} \frac{{k}_{2} t}{1 + {k}_{2} t} ; \qquad ( 3 )$$

$$Elovich : {q}_{t} = β ln ( a β ) + β ln t ; \qquad ( 4 )$$

$$Weber and Morris : {q}_{t} = {K}_{diff} {t}^{0.5} + C ; \qquad ( 5 )$$

where qₑ (mg/g) is the amount of adsorbed PFOA at equilibrium; qₜ (mg/g) is the amount of adsorbed PFOA at any time t; k₁ (h⁻¹) and k₂ (h⁻¹) are the adsorption rate constant of pseudo-first-order and pseudo-second-order reactions, respectively; α (mg/g·h) and β (g/mg) are the initial adsorption rate and desorption constant, respectively; K_{diff} (mg/g·h^{0.5}) and C (mg/g) represent the intraparticle diffusion rate and constant, respectively.

The kinetic model fitting parameters were listed in Table 2 with the calculated correlation values (R2) sequence of PSO (0.978)>Elovich (0.925)>PFO (0.860). The good fitting with PSO indicates that plenty of adsorption sites (amine and amide groups) exist on the surface of GO-PEI3. The Elovich equation is suitable for describing chemical adsorption. However, compared with PSO, the low R² value calculated for the Elovich model revealed that chemisorption can not be the dominating mechanism during the adsorption of PFOA onto GO-PEI3.

TABLE 2
Kinetic study data fitting parameters

| Kinetic model | Parameters | Values |
|---|---|---|
| Experimental data | qₑ exp (mg/g) | 302.40 |
| PFO | qₑ cal (mg/g) | 292.30 |
| | k₁ (h⁻¹) | 2.14 |
| | R² | 0.86 |
| PSO | qₑ cal (mg/g) | 306.90 |
| | k₂ (h⁻¹) | 0.01 |
| | R² | 0.98 |
| Elovich | qₑ cal (mg/g) | 331.00 |
| | α (mg/g · h) | 28.98 |
| | β (g/mg) | 34.43 |
| | R² | 0.93 |

The intra-particle diffusion model has been widely employed to examine the rate-limiting step during adsorption. On the other hand, the Weber Morris Intra-Particle diffusion (Equation 5) kinetic model was used to fit the kinetic data. As shown in FIG. 4D, the adsorption process of PFOA onto GO-PEI3 could be linearly fitted to three stages. In the first stage, the straight-line fitting failed to pass the origin which implies that intra-particle diffusion exhibited a relatively low influence on PFOA adsorption onto GO-PEI3. In the second stage, the high positive C=194.69 mg/g value indicates that the boundary layer diffusion can have a comparable effect on the adsorption process while the last step being the final equilibrium stage. Overall, the PFOA adsorption onto GO-PEI3 appeared to be mainly controlled by surface adsorption but not mass transfer and inner-pore diffusion processes.

### Adsorption Isotherm

To further study the adsorption behavior of PFOA onto GO-PEI3, adsorption isotherm data were fitted by the Langmuir, Freundlich, and BET models (Equations 6-8). FIG. 4E proves that the BET model best describes PFOA adsorption with the highest correlation coefficient (R²) value. The model parameters were listed in Table 3. The BET model is considered as a special combination of the monolayer and multilayer isotherm model since it clearly explains the PFOA adsorption process and calculates the maximum monolayer PFOA adsorption onto GO-PEI3. The well-fit of the BET isotherm model indicates that the surface of GO-PEI3 was initially dominated by monolayer PFOA adsorption in low PFOA concentrations, followed by the PFOA aggregation on the first monolayer when increasing the PFOA concentration, then forming into multilayer PFOA adsorption on the surface of GO-PEI3. Based on the BET model calculation, the maximum monolayer adsorption capacity reached 231.2 mg/g (qm). After the monolayer adsorption, the adsorbed PFOA molecules on GO-PEI3 could act as adsorption sites attracting more PFOA from bulk solution through hydrophobic interaction. In this work, the calculated Cs value of PFOA was found at 169.9 mg/L which closely corresponds with the critical micelle concentration (CMCPFOA) value (157.0 mg/L) reported in literature. Therefore, it is possible to form some multilayer hemi-micelles and micelles PFOA structures on the surface of GO-PEI3 with high PFOA loading. The equations for the models are as follows:

$$Langmuir model : {q}_{e} = \frac{{q}_{max} {K}_{L} {C}_{e}}{1 + {K}_{L} {C}_{e}} ; \qquad ( 6 )$$

$$Freundlich model : {q}_{e} = {K}_{F} {C}_{e}^{1 / n} ; \qquad ( 7 )$$

$$BET model : {q}_{e} = \frac{{q}_{m} {K}_{B E T} {C}_{e}}{( {C}_{s} - {C}_{e} ) [ 1 + ( {K}_{B E T} - 1 ) ( \frac{{C}_{e}}{{C}_{s}} ) ]} ; \qquad ( 8 )$$

where qₑ (mg/g) is the equilibrium amount of adsorption PFOA onto GO-PEI3; qₘₐₓ (mg/g) is the maximum monolayer adsorption capacity of GO-PEI3; Ce (mg/L) is the PFOA concentration at equilibrium; K_{L} (L/mg) is the Langmuir Isotherm constant related to the affinity of binding sites; K_{F} and n are the Freundlich constant and intensity factor; K_{BET} is the equilibrium sorption constants (L/g), qm is the monolayer sorption capacity of the adsorbent (mg/g), C_{S} is the saturated concentration of the adsorbate in the aqueous phase (mg/L), respectively.

TABLE 3
Isotherm study data fitting parameters of GO-PEI3

| Isotherm model | Parameters | Values |
|---|---|---|
| Experimental | qₑ exp (mg/g) | 358.00 |
| Langmuir | qₑ cal (mg/g) | 271.00 |
| | K_{L} (L/mg) | 0.81 |
| | R² | 0.90 |
| Freundlich | qe cal (mg/g) | 347.80 |
| | K_{F} | 113.10 |
| | n | 3.70 |
| | R² | 0.98 |
| BET | qₑ cal (mg/g) | 368.20 |
| | qₘ (mg/g) | 231.20 |
| | K (L/g) | 185.10 |
| | Cₛ (mg/L) | 169.90 |
| | R² | 0.99 |

### Impact of Humic Acid

Humic acid (HA) is a naturally existing organic matter that is ubiquitous in most surface waters and some wastewaters. Different concentrations of HA in PFOA solutions were tested (constant initial pH 4.0) to assess the impact of HA on PFOA adsorption onto GO-PEI3. The PFOA adsorption capacity continuously decreased with the increase in HA concentration (FIG. 4F). The kinetic study of HA in FIG. 4F shows that the adsorption of HA was much faster than PFOA (based on their K₂ values from pseudo-second-order kinetics, 0.973 h⁻¹ for HA, 0.014 h⁻¹ for PFOA, respectively). This demonstrates that the surface of GO-PEI3 was occupied by HA first, consequently leaving limited adsorption sites for PFOA. FIG. 4F also presents that small amounts of HA were adsorbed but caused a significant inhibition effect on PFOA adsorption. Since the attached HA on GO-PEI3 was mainly composed of negatively charged hydroxyl and carboxyl groups, these functional groups could result in electrostatic repulsion with PFOA anions.

### Effect of Ionic Strength and Various Ions

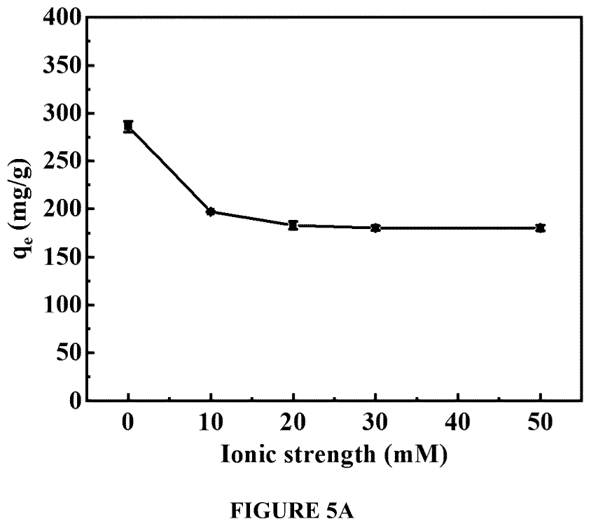

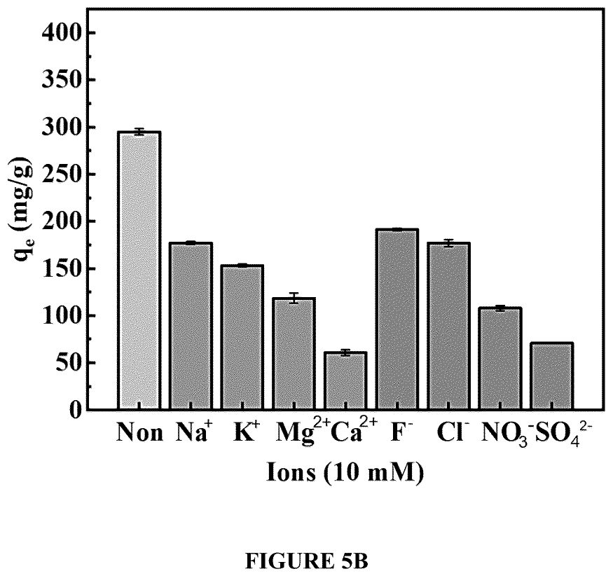

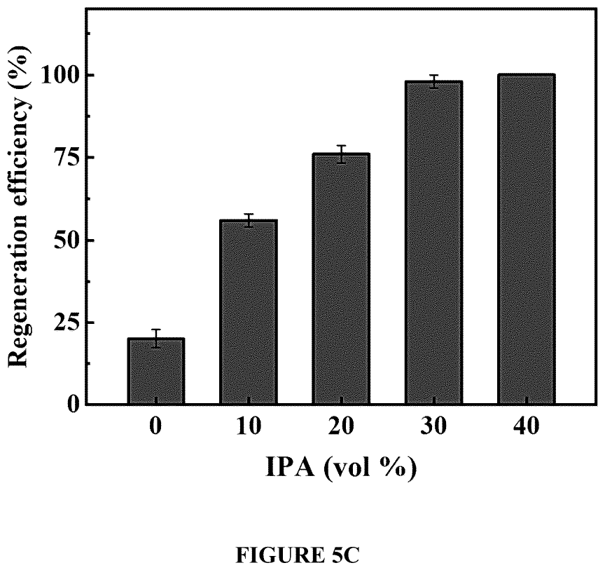

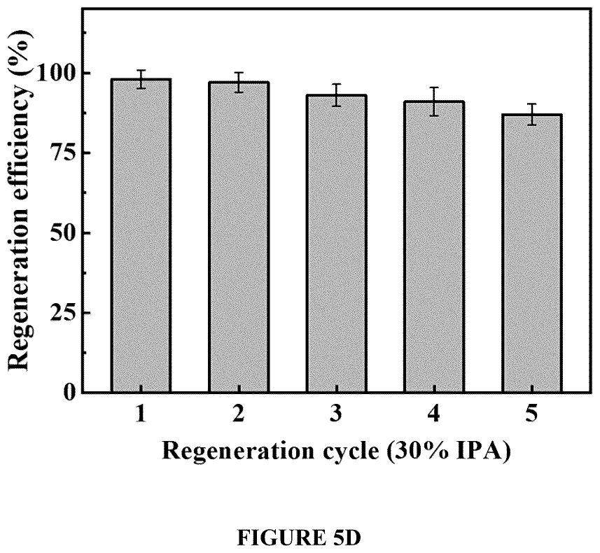

NaCl is one of the most common salts in water and its content varies in different water bodies. FIG. 5A shows the influence of ionic strength of NaCl on PFOA adsorption (constant initial pH 4.0) wherein a decreasing trend of PFOA removal was seen with the increase in NaCl concentration especially within the range of 0-10 mM. As observed in FIG. 5B, all the additional salts caused the reduction of PFOA adsorption since the anions in PFOA solution could screen the adsorption sites by forming the electric double layers compression (screening effect). Similar explanations were also stated in previous studies. Hence, the strength of attraction between the positively charged GO-PEI3 and negatively charged PFOA molecules was inhibited. GO-PEI3 became less favorable to PFOA in high ionic strength causing the reduction in PFOA adsorption.

In addition to the influence of ionic strength, cations and anions complexation were also considered. The effects of different cations (chlorine salts: Na⁺, K⁺, Mg²⁺, Ca²⁺) and anions (sodium salts: F⁻, Cl⁻, NO₃⁻, SO₄²⁻) on adsorption (constant initial pH 4.0) were investigated (FIG. 5B). Compared with Na⁺ and K⁺, the inhibition effects of Mg²⁺ and Ca²⁺ on PFOA adsorption were more evident. It has been reported that the reduction in PFOA adsorption can be caused by the formation of divalent cation PFOA salts resulting in the decrease in electrostatic interaction due to the absence of PFOA anions in bulk solutions. Since Ca²⁺ has a larger ion radius than Mg²⁺, Ca²⁺ can bind with the carboxylic group well than Mg²⁺. Due to the limited PFOA anions, PFOA adsorption capacity on GO-PEI3 further decreased when the Ca²⁺ co-existed in solution. The potential divalent bridge formation is described in the following reaction (Equation 9):

$$2 [ C {{F}_{3} ( C {F}_{2} )}_{6} {COO}^{-} ] + {M}^{2 +} \to {M [ C {{F}_{3} ( C {F}_{2} )}_{6} COO ]}_{2} . \qquad ( 9 )$$

Various species of anions also inhibited PFOA adsorption onto GO-PEI3 (FIG. 5B) especially SO₄²⁻ which appeared to have the most significant effect. It has been summarized that the salts (anions) cannot only affect the adsorption by electrical double-layer compression (screening effect), but also competed with PFOA anions for the amine groups on GO-PEI3 leading to a reduction of PFOA adsorption.

Desorption Experiment and Comparison with Other Adsorbents

After the full loading of PFOA on the GO-PEI3, desorption of the spent GO-PEI3 using different concentrations of IPA reagents were tested for reusability. FIG. 5C demonstrates that the regeneration efficiency was less than 20% using DI water. When the mixture of IPA and DI water was utilized as the regeneration solution, the regeneration efficiency increased dramatically (98.01% at 30% IPA and 100% at 40% IPA). The presence of IPA could induce the PFOA desorption from GO-PEI3. Without wanting to be bound by theory, this phenomena could be explained by the “like-dissolves-like” rule because the non-polar solvents are expected to have better solubility for the hydrophobic PFOA. The 30% IPA solution was selected as the regeneration reagent in the subsequent adsorption-desorption cycles (FIG. 5D) to further investigate the desorption of PFOA from GO-PEI3. After 5 cycles, the PFOA adsorption capacity of GO-PEI3 remained at 87.14% which provides a promising result for adsorbent reusability of GO-PEI3.

### Adsorption Mechanisms

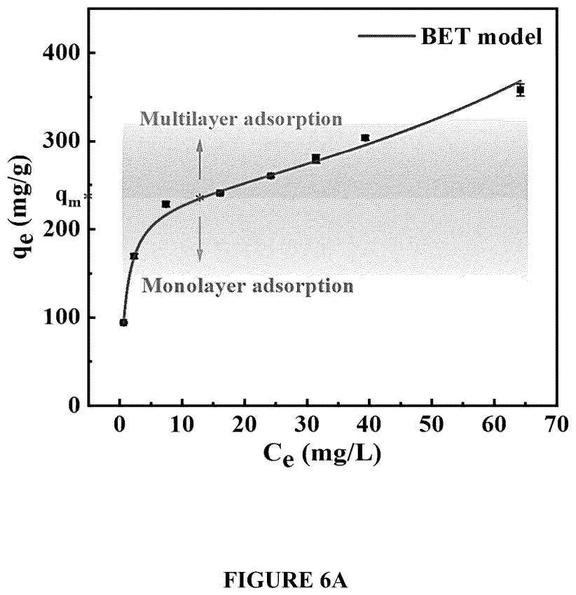

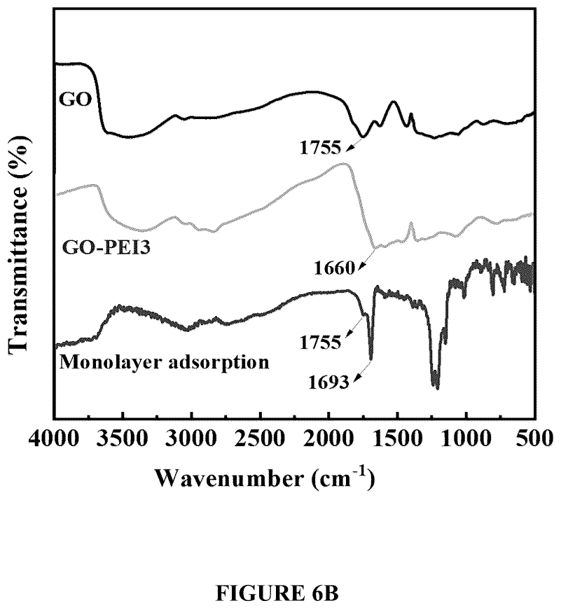

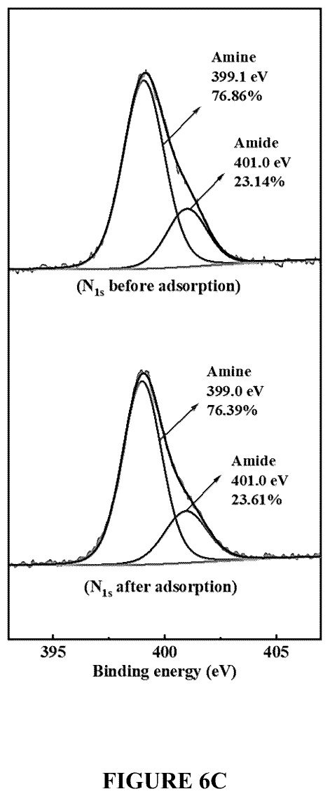

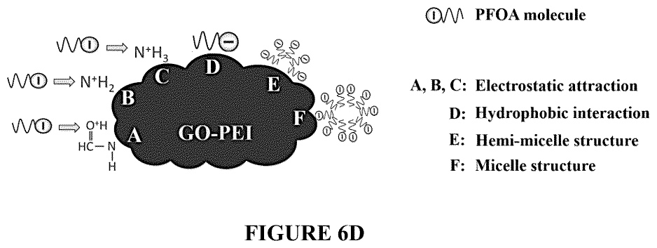

The adsorption of PFOA onto GO-PEI3 behaved as monolayer adsorption when the adsorption capacity was below qm, and multilayer adsorption when the adsorption capacity was above qm (FIGS. 4E and 6A). The spent GO-PEI3 with monolayer PFOA adsorption was tested with FT-IR to investigate the first layer adsorption mechanism. After the monolayer PFOA adsorption (FIG. 6B), the C═O vibration in the carboxyl group (—COOH) in PFOA was detected at 1755 cm⁻¹ which signifies that the chemical reaction cannot be the dominating adsorption mechanism. It was notable that after PFOA adsorption, the peak of amide I showed a left shift moving from 1660 cm⁻¹ to 1693 cm⁻¹. The possible reason for this shift is that the amide I group in GO-PEI3 was protonated and became positively charged after PFOA adsorption.

XPS was used to identify the functional groups and their content ratios on the surface of GO-PEI3 before and after PFOA adsorption. As shown in FIG. 6C, the contents of amide and amine groups before and after the PFOA adsorption were almost similar. This means that the adsorption was not dominated by forming new amide groups (chemical reaction) from the reaction between amine groups (—NH₂) in GO-PEI3 and carboxyl groups (—COOH) in PFOA, but through the electrostatic attraction or hydrophobic interaction (physical adsorption) between the adsorbent and adsorbate.

When the pH value was lower than 7.9 (pH_{pzc}), the protonated amine groups made the GO-PEI3 positively charged and more electrophilic. Specifically, the amide and amine groups on GO-PEI3 took hydrogen ions (H⁺) from the aqueous solution and protonated as positively charged —(CO⁺HNH)—, —(N⁺H₂)— and —(N⁺H₃), adsorbing the PFOA anions from water through electrostatic attraction (FIGS. 6D: A, B, C).

PFOA could be adsorbed onto GO-PEI3 through hydrophobic interaction (FIG. 6D: D). And the hydrophobic tail of adsorbed PFOA on GO-PEI3 could serve as the adsorption site for the PFOA in the remaining solution thus facilitating multilayer adsorption, which was also well-described by the BET isotherm model. Due to hydrophobic aggregation, the multilayer adsorbed PFOA can form into hemi-micelle structure or micelle structure on the surface of GO-PEI3 (FIG. 6D: E, F).

One of ordinary skill in the art will readily appreciate that alternative but functionally equivalent components, materials, designs, and equipment can be used. The inclusion of additional elements can be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention. Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present invention is intended to embrace all such alternatives, modifications, and variations as fall within the scope of the claims, together with all equivalents thereof.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. As used herein, use of the term “including” as well as other forms, such as “includes,” and “included,” is not limiting.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits can be the values from the examples. Certain lower limits, upper limits and ranges appear in at least one claims below. All numerical values are “about” or “approximately” the indicated value, and consider experimental error and variations that would be expected by a person having ordinary skill in the art.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components illustrated above should not be understood as requiring such separation, and it should be understood that the described program components and systems can generally be integrated together in a single software product or packaged into multiple software products.

All patents, patent applications, provisional applications, and publications referred to or cited herein are incorporated by reference in their entirety, including all figures and tables, to the extent they are not inconsistent with the explicit teachings of this specification.

What is claimed is:

1. A polyethyleneimine modified graphene oxide comprising:
graphene oxide; and
polyethylene, wherein the polyethyleneimine modified graphene oxide has a weight percent of graphene oxide from about 1 wt % to about 99 wt %, and wherein the polyethyleneimine modified graphene oxide has a weight percent of polyethyleneimine from about 99 wt % to about 1 wt %.

2. The polyethyleneimine modified graphene oxide of claim 1, wherein the polyethyleneimine modified graphene oxide has a molecular weight from about 300 g/mol to about 200,000 g/mol.

3. The polyethyleneimine modified graphene oxide of claim 1, wherein the polyethyleneimine of the polyethyleneimine modified graphene oxide has a molecular weight from about 750 g/mol to about 850 g/mol.

4. A method of making a polyethyleneimine modified graphene oxide comprising:
contacting graphene oxide with polyethyleneimine to make a polyethyleneimine modified graphene oxide, wherein the polyethyleneimine modified graphene oxide has a weight percent of graphene oxide from about 1 wt % to about 99 wt %, and wherein the polyethyleneimine modified graphene oxide has a weight percent of polyethyleneimine from about 99 wt % to about 1 wt %.

5. The method of claim 4, wherein the polyethyleneimine modified graphene oxide has a molecular weight from about 300 g/mol to about 200,000 g/mol.

6. The method of claim 4, wherein the polyethyleneimine modified graphene oxide has a molecular weight from about 750 g/mol to about 850 g/mol.

7. A method of using a polyethyleneimine modified graphene oxide to remove a contaminant from an aqueous mixture comprising:
contacting a polyethyleneimine modified graphene oxide composition with an aqueous mixture containing a contaminant to at least partially reduce the concentration of the contaminant.

8. The method of claim 7, wherein the polyethyleneimine modified graphene oxide has a molecular weight from about 300 g/mol to about 200,000 g/mol.

9. The method of claim 7, wherein the polyethyleneimine of the polyethyleneimine modified graphene oxide has a molecular weight from about 750 g/mol to about 850 g/mol.

10. The method of claim 7, wherein the contaminant comprises perfluorooctanoic acid.

11. The method of claim 7, wherein a concentration of a contaminant is reduced by about 45 wt % to about 55 wt %.

12. The method of claim 7 further comprising:
contacting the polyethyleneimine modified graphene oxide with isopropyl alcohol.

13. The method of claim 7, wherein the polyethyleneimine modified graphene oxide composition further comprises a chemical oxidizer.

14. The method of claim 7 further comprising:
one or more column contactors and slurry form for treating polluted waters.

15. The method of claim 7 further comprising: resulting adsorbents can also be used as a medium to support microbial growth with the adsorbent serving not only as the structural support but also as a pollutant concentrator which can feed the microbial population.

16. The method of claim 13, wherein the chemical oxidizer is ozone.

17. The method of claim 13, wherein the chemical oxidizer is hydrogen peroxide.
